(19) United States
(12) Patent Application Publication
(10) Pub. No.: US 2025/0304786 A1
(43) Pub. Date: Oct. 2, 2025

(54) RESIN COMPOSITION AND ARTICLE MANUFACTURED USING THE SAME

(71) Applicant: Elite Material Co., Ltd., Taoyuan City (TW)

(72) Inventor: Shu-Hao CHANG, Taoyuan City (TW)

(21) Appl. No.: 18/661,866

(22) Filed: May 13, 2024

(30) Foreign Application Priority Data
Mar. 28, 2024 (TW) 113111683

(51) Int. Cl. C08L 71/12; C08J 5/24

(52) U.S. Cl. CPC C08L 71/126; C08J 5/244; C08J 2371/12; C08L 2203/16; C08L 2203/20

(57) ABSTRACT

A resin composition includes 100 parts by weight of a vinyl-containing polyphenylene ether resin; 20 parts by weight to 60 parts by weight of a compound represented by the following formula (1); and 20 parts by weight to 60 parts by weight of an ethylene-styrene-divinylbenzene terpolymer,

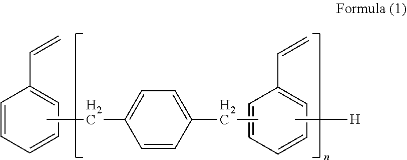

wherein n is an integer ranging from 1 to 20. An article manufactured using the aforesaid resin composition is also provided.

### CROSS-REFERENCE TO RELATED APPLICATIONS

This application claims the benefits of the Taiwan Patent Application Serial Number 113111683, filed on Mar. 28, 2024, the subject matter of which is incorporated herein by reference.

### BACKGROUND OF THE INVENTION

### Field

The present invention provides a resin composition and an article manufactured using the same. More specifically, the present invention provides a resin composition with improved properties and an article manufactured using the same.

### Description of Related Art

The operation of electronic equipment is achieved by connecting numerous electronic components through conductive lines on the circuit board for power supply and signal transmission. A circuit board is generally composed of a circuit substrate and a conductive circuit pattern disposed on the circuit substrate.

With the rapid development of the fifth-generation mobile communication technology (5G) and the high functionality and miniaturization of the electronic equipment, the circuit boards used are also developing in the direction of multi-layering, high-density wiring and high-speed signal transmission. In addition, in order to ensure the quality of electronic equipment, there are also higher requirements for the overall performance of circuit substrates (such as printed circuit boards). The resin composition is the basic raw material for preparing circuit substrates. The design of the resin composition directly affects the performance of circuit substrates.

Therefore, how to develop a resin composition suitable for high-performance circuit substrates is the current direction of the industry's active efforts.

### SUMMARY OF THE INVENTION

In view of the problems encountered in the prior art, especially the inability of existing resin compositions to meet one or more of the above performance requirements, the main object of the present invention is to provide a resin composition and an article thereof that can meet the above performance requirements.

The present invention provides a resin composition, which comprises: 100 parts by weight of vinyl-containing polyphenylene ether resin; 20 parts by weight to 60 parts by weight of a compound represented by the following formula (1); and 20 parts by weight to 60 parts by weight of an ethylene-styrene-divinylbenzene terpolymer,

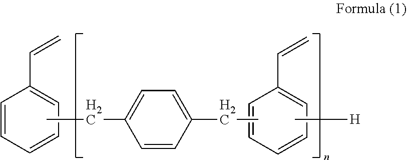

wherein n is an integer ranging from 1 to 20.

The present invention also provides an article manufactured using the aforesaid resin composition, wherein the article includes a prepreg, a resin film, a laminate or a printed circuit board.

The article manufactured using the resin composition of the present invention, such as a prepreg, a resin film, a laminate or a printed circuit board, has excellent characteristics in at least one of the copper foil peeling strength of the copper-containing laminate, the heat resistance of the multilayer laminate, the appearance of the prepreg, and the appearance of the laminate, and therefore can be used as a high-performance laminate that meet comprehensive needs.

Other novel features of the disclosure will become more apparent from the following detailed description when taken in conjunction with the accompanying drawings.

### BRIEF DESCRIPTION OF DRAWINGS

FIG. 1 is a schematic diagram showing the uneven appearance of the prepreg.

FIG. 2 is a schematic diagram showing the normal appearance of the prepreg.

FIG. 3 is a schematic diagram showing the appearance of the laminate with the texture exposed.

FIG. 4 is a schematic diagram showing the appearance of the laminate without texture exposed.

### DETAILED DESCRIPTION OF THE INVENTION

The following examples are only used to illustrate the embodiments of the present invention and are not intended to limit the present invention.

The terms used herein have the same meaning as those generally understood by the skilled person in the art. If otherwise specified herein, the terms defined herein shall prevail.

In the present specification, the terms “comprise”, “include”, “have”, “contain” or any other similar terms are open-ended transitional phrases. The terms “consisting of” and “consist” are closed-transitional phrases.

Numerical ranges used herein include all possible subranges, and all individual numerical values (including decimals and integers) within the stated range.

Numerical values used herein include all numerical ranges that are equal to the numerical values after rounding to the number of significant digits in the numerical values.

The polymer used herein includes homopolymers, copolymers, prepolymers, etc., but the present invention is not limited thereto. The polymer also includes oligomers.

In the present specification, the “copolymer” refers to the product formed by polymerization reaction of two or more kinds of monomers, and includes but not limited to random copolymers (for example, but not limited to -AABABBBAAABBA-, wherein A and B respectively represent two monomers with different chemical structural formulas), alternating copolymers (the structure is for example, but not limited to -ABABABAB-), graft copolymers (the structure is for example, but not limited to -AA(A-BBBB)AA(A-BBBB)AAA-) or block copolymers (the structure is for example, but not limited to -AAAAA-BBBBBB-AAAAA-). For example, a styrene-butadiene copolymer is a product obtained by polymerization of only two kinds of monomers of styrene and butadiene. For example, styrene-butadiene copolymers include, but are not limited to styrene-butadiene random copolymers, styrene-butadiene alternating copolymers, styrene-butadiene graft copolymers or styrene-butadiene block copolymers. Styrene-butadiene block copolymers include, but are not limited to, the polymerized molecular structure of styrene-styrene-styrene-butadiene-butadiene-butadiene-butadiene. Styrene-butadiene block copolymers include, for example, but are not limited to, styrene-butadiene-styrene block copolymers. Styrene-butadiene-styrene block copolymers include, for example, but are not limited to, the polymerized molecular structure of styrene-styrene-styrene-butadiene-butadiene-butadiene-butadiene-styrene-styrene-styrene. Similarly, hydrogenated styrene-butadiene copolymers include hydrogenated styrene-butadiene random copolymers, hydrogenated styrene-butadiene alternating copolymers, hydrogenated styrene-butadiene graft copolymers or hydrogenated styrene-butadiene block copolymer. Hydrogenated styrene-butadiene block copolymers include, for example but are not limited to, hydrogenated styrene-butadiene-styrene block copolymers.

In the present invention, “resin” may include, but is not limited to monomers, polymers formed by monomers, combinations of monomers, combinations of polymers formed by monomers or combinations of monomers and polymers formed by monomers when interpretation. For example, in the present invention, “maleimide resin” includes maleimide monomers, maleimide polymers formed by maleimide monomers, combinations of maleimide monomers, combinations of maleimide polymers formed by maleimide monomers or combinations of maleimide monomers and maleimide polymers formed by maleimide monomers.

In the present specification, “vinyl group-containing” may include vinyl group, vinylene group, allyl group, (meth)acrylate group or vinylbenzyl group.

In the present invention, a modification includes: the product that the reaction functional group of the resin is modified, the product formed by the prepolymerization reaction of the resin and other resin, the product formed by the cross-linking between the resin and other resin, homopolymerized products of the resin, copolymerized products of the resin with other resins, etc. For example, the modification may be to replace the original terminal hydroxyl group with a terminal vinyl group through a chemical reaction, or to obtain a terminal hydroxyl group through a chemical reaction between the original terminal vinyl group and p-aminophenol.

In the present specification, the “unsaturated bond” refers to the reactive unsaturated bond, such as but not limited to the unsaturated double bond that can cross-link with other functional groups, such as but not limited to the unsaturated carbon-carbon double bond that can cross-link with other functional groups.

In the present specification, when specific examples of compounds are written in the form of “(substituent)”, they should be understood to include both cases with this substituent and cases without this substituent. For example, cyclohexanedimethanol di(meth)acrylate should be interpreted as including cyclohexanedimethanol diacrylate and cyclohexanedimethanol dimethacrylate; and (meth)acrylate should be interpreted as including acrylate and methacrylate.

In the present specification, part(s) by weight represents weight part(s), which can be any weight unit, such as but not limited to kilogram(s), gram(s), pound(s) and other weight units. For example, 100 parts by weight of maleimide resin means that it can be 100 kg of maleimide resin or 100 lbs of maleimide resin. If the resin solution includes solvent and resin, the parts by weight of the (solid or liquid) resin generally refers to the weight unit of the (solid or liquid) resin, and does not include the weight unit of the solvent in the solution. The parts by weight of the solvent refer to the weight unit of the solvent.

The present invention comprises a resin composition, comprising: 100 parts by weight of vinyl-containing polyphenylene ether resin; 20 parts by weight to 60 parts by weight of a compound represented by the following formula (1); and 20 parts by weight to 60 parts by weight of an ethylene-styrene-divinylbenzene terpolymer,

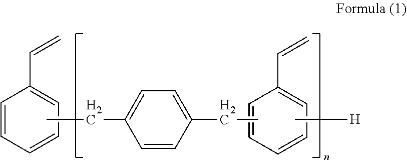

wherein n is an integer ranging from 1 to 20.

In one embodiment, the content of the vinyl-containing polyphenylene ether resin is 100 parts by weight, and the contents of other resins or additives are the relative contents related to 100 parts by weight of the vinyl-containing polyphenylene ether resin. For example, unless otherwise specified, in one embodiment of the present invention, the content of the compound having the structure shown in Formula (1) may be 20 parts by weight to 60 parts by weight relative to 100 parts by weight of the vinyl-containing polyphenylene ether resin. Similarly, in one embodiment of the present invention, the content of the ethylene-styrene-divinylbenzene terpolymer may be 20 parts by weight to 60 parts by weight relative to 100 parts by weight of the vinyl-containing polyphenylene ether resin. For example, in one embodiment of the present invention, the resin composition may comprise: 100 kg of the vinyl-containing polyphenylene ether resin, 20 kg to 60 kg of the compound represented by the formula (1), and 20 kg to 60 kg of the ethylene-styrene-divinylbenzene terpolymer. For example, in one embodiment of the present invention, the resin composition may comprise 100 pounds of the vinyl-containing polyphenylene ether resin, 20 pounds to 60 pounds of the compound represented by the formula (1), and 20 pounds to 60 pounds of the ethylene-styrene-divinylbenzene terpolymer.

In one embodiment, the vinyl-containing polyphenylene ether resin may include various polyphenylene ether resins with terminals modified by vinyl, allyl or vinylene. The vinyl-containing polyphenylene ether resin may comprise but is not limited to: vinylbenzyl group-containing polyphenylene ether resin, (meth)acrylate-containing polyphenylene ether resin, vinylbenzyl group-containing bisphenol A polyphenylene ether resin or maleimide-containing polyphenylene ether resin. The vinyl-containing polyphenylene ether resins with terminals modified by vinyl, allyl or vinylene may be polymerized through the unsaturated bonds.

In one embodiment, the vinyl-containing polyphenylene ether resin may comprise various vinyl-containing polyphenylene ether resins known in the art. The vinyl-containing polyphenylene ether resin suitable for the present invention is not particularly limited and can be any one or more commercially available products or homemade products. In some embodiments, any one or more of the following vinyl-containing polyphenylene ether resins may be used: vinylbenzyl biphenyl-containing polyphenylene ether resin (such as OPE-2st, available from Mitsubishi Gas Chemical Co., Ltd.), methacrylate-containing polyphenylene ether resin (such as SA9000, available from Sabic Company) or vinylbenzyl group-containing bisphenol A polyphenylene ether resin. However, the present invention is not limited thereto.

In one embodiment, in the compound having the structure represented by the formula (1), n represents the repeating number of the structural unit in parentheses, and n is an integer from 1 to 20. For example, in one embodiment, n may be 1, 2, 3, 4, 5, 6, 7, 8, 9, 10, 11, 12, 13, 14, 15, 16, 17, 18, 19 or 20. The compound having the structure represented by the formula (1) may be obtained from commercial products or can be prepared according to known methods. For example, the compound having the structure represented by the formula (1) may be prepared by referring to the method described in Synthesis Example 1 below, but is not limited thereto. Herein, the reagents, using amounts and conditions used in Synthesis Example 1 may be adjusted by those with ordinary knowledge in the art without excessive experimentation to prepare the compound having the structure represented by the formula (1).

In one embodiment, the aforesaid ethylene-styrene-divinylbenzene terpolymer may be a polymerized product containing three monomers of divinylbenzene, styrene and ethylene obtained through the polymerization reaction of the raw materials of the three monomers of divinylbenzene, styrene and ethylene. The aforesaid ethylene-styrene-divinylbenzene terpolymer obtained by the polymerization may be a random copolymer, that is, the three monomers of divinylbenzene, styrene, and ethylene are cross-linked with each other through random arrangements. In another embodiment, the divinylbenzene in the raw material of the monomer of ethylene-styrene-divinylbenzene terpolymer can be p-divinylbenzene.

In one embodiment, the number average molecular weight (Mn) of the ethylene-styrene-divinylbenzene terpolymer may range from 5,000 to 15,000. In another embodiment, the number average molecular weight of the ethylene-styrene-divinylbenzene terpolymer may range from 5,000 to 11,000. In further embodiment, the number average molecular weight of the ethylene-styrene-divinylbenzene terpolymer may range from 6,000 to 10,000.

In one embodiment, the ethylene-styrene-divinylbenzene terpolymer is polymerized from a mixture; wherein the mixture comprises 40 mol % to 80 mol % of an ethylene monomer, 20 mol % to 60 mol % of a styrene monomer and 0.01 mol % to 10 mol % of a divinylbenzene monomer, and a total amount of the ethylene monomer, the styrene monomer and the divinylbenzene monomer is 100 mol %. In another embodiment, in the polymerization raw materials of the ethylene-styrene-divinylbenzene terpolymer, the amount of the ethylene may be about 40 mol % to 80 mol %, the amount of the styrene may be about 20 mol % to 60 mol %, the amount of the divinylbenzene may be about 0.01 mol % to 10 mol %, and the total amount of the divinylbenzene, the styrene and the ethylene is 100 mol %. In other embodiments, in the polymerization raw materials of the ethylene-styrene-divinylbenzene terpolymer, the amount of the ethylene may be 40 mol % to 80 mol %, the amount of the styrene may be 20 mol % to 60 mol %, the amount of the divinylbenzene may be 0.01 mol % to 1 mol %, and the total amount of the divinylbenzene, the styrene and the ethylene is 100 mol %. In one embodiment, in the polymerization raw materials of the ethylene-styrene-divinylbenzene terpolymer, the amount of ethylene may be about 39.99 mol % to 80 mol %, the amount of the styrene may be about 19.99 mol % to 60 mol %, the amount of the divinylbenzene may be about 0.01 mol % to 10 mol %, and the total amount of the divinylbenzene, the styrene and the ethylene is 100 mol %. In other embodiments, in the polymerization raw materials of the ethylene-styrene-divinylbenzene terpolymer, the amount of the ethylene is 80 mol %, the amount of the styrene is 19.99 mol % (as explained above, the value 19.99 can be represented by the value 20, that is 20 mol %), the amount of the divinylbenzene may be 0.01 mol %, and the total amount of the ethylene, the styrene and the divinylbenzene is 100 mol %. In other embodiments, in the polymerization raw materials of the ethylene-styrene-divinylbenzene terpolymer, the amount of the ethylene is 39.99 mol % (as explained above, the value 39.99 can be represented by the value 40, that is 40 mol %), the amount of the styrene is 60 mol %, the amount of the divinylbenzene is 0.01 mol %, and the total amount of the ethylene, the styrene and the divinylbenzene is 100 mol %. In other embodiments, in the polymerization raw materials of the ethylene-styrene-divinylbenzene terpolymer, the amount of the ethylene may be about 60 mol % to 80 mol %, the amount of the styrene may be about 20 mol % to 30 mol %, the amount of the divinylbenzene may be about 0.01 mol % to 10 mol %, and the total amount of the divinylbenzene, the styrene and the ethylene is 100 mol %. In other embodiments, in the polymerization raw materials of the ethylene-styrene-divinylbenzene terpolymer, the amount of the ethylene may be 60 mol % to 80 mol %, the amount of the styrene may be 20 mol % to 30 mol %, the amount of the divinylbenzene may be 0.01 mol % to 10 mol %, and the total amount of the divinylbenzene, the styrene and the ethylene is 100 mol %. In other embodiments, in the polymerized raw materials of the ethylene-styrene-divinylbenzene terpolymer, the amount of the ethylene may be 60 mol % to 80 mol %, the amount of the styrene may be 19.99 mol % to 30 mol %, the amount of the divinylbenzene may be 0.01 mol % to 10 mol %, and the total amount of the divinylbenzene, the styrene and the ethylene is 100 mol %. In other embodiments, in the polymerization raw materials of the ethylene-styrene-divinylbenzene terpolymer, the amount of the ethylene may be about 70 mol % to 80 mol %, the amount of the styrene may be about 20 mol % to 30 mol %, the amount of the divinylbenzene may be about 0.01 mol % to 1 mol %, and the total amount of the divinylbenzene, the styrene and the ethylene is 100 mol %. In other embodiments, in the polymerization raw materials of the ethylene-styrene-divinylbenzene terpolymer, the amount of the ethylene may be 70 mol % to 80 mol %, the amount of the styrene may be 20 mol % to 30 mol %, the amount of the divinylbenzene may be 0.01 mol % to 1 mol %, and the total amount of the divinylbenzene, the styrene and the ethylene is 100 mol %.

In one embodiment, the resin composition may further comprise maleimide resin, polyolefin other than the ethylene-styrene-divinylbenzene terpolymer, acrylate, triallyl isocyanurate (TAIC), triallyl cyanurate, styrene maleic anhydride copolymer resin, phenol resin, benzodiazepine resin, cyanate resin, polysiloxane resin, polyester resin, epoxy resin, polyamide resin, polyimide resin or a combination thereof.

In one embodiment, the resin composition may further selectively comprise a maleimide resin. Examples of the maleimide resin may include, but are not limited to 4,4′-diphenylmethane bismaleimide, polyphenylmethane maleimide (or called as oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide, maleimide with biphenyl structure, maleimide resin containing C₁₀₋₅₀ aliphatic long chain structure, prepolymer of diallyl compound and maleimide resin, prepolymer of multifunctional amine and maleimide resin (herein, the multifunctional amine includes two or more amine groups), or prepolymer of aminophenol and maleimide resin.

For example, specific examples of maleimide resin include, but are not limited to, maleimide resin produced by Daiwakasei Industry Co., Ltd. with trade names BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 or BMI-7000H, maleimide resin produced by K.I Chemical Co., Ltd. with trade names BMI-70 or BMI-80, or maleimide resin produced by Nippon Kayaku Co., Ltd. with trade names MIR-3000 or MIR-5000.

For example, specific examples of maleimide resin containing C₁₀₋₅₀ aliphatic long chain structure include, but are not limited to, maleimide resin containing C₁₀₋₅₀ aliphatic long chain structure produced by Designer Molecular Co., Ltd. with trade names BMI-689, BMI-1400, BMI-1500, BMI-1700, BMI-2500, BMI-3000, BMI-5000 or BMI-6000, or maleimide resin containing C₁₀0.5 aliphatic long chain structure produced by Shin-etsu chemical co., Ltd. with trade names SLK-3000 series, SLK-1500 series or SLK-2000 series. The structure of SLK-3000 produced by Shin-etsu chemical co., Ltd. is the same as the structure of BMI-3000 produced by Designer Molecular Co., Ltd.

In one embodiment, the content of the maleimide resin is not particularly limited. In another embodiment, with respect to 100 parts by weight of the vinyl-containing polyphenylene ether resin, the resin composition may further comprise 1 part by weight to 20 parts by weight of the maleimide resin, and preferably 1 parts by weight to 10 parts by weight of the maleimide resin, but the present invention is not limited thereto. In further another embodiment, the resin composition may not comprise the maleimide resin, and at this time the content of the maleimide resin is 0 parts by weight; here, it means that the maleimide resin is not intentionally added into the resin composition. In further another embodiment, when the resin composition comprises maleimide resin, the content of the maleimide resin may be 1, 2, 3, 4, 5, 6, 7, 8, 9, 10, 15 or 20 parts by weight. However, the present invention is not limited thereto, and the content of the maleimide resin may be adjusted according to the needs.

In one embodiment, the resin composition may selectively further comprise polyolefin other than the ethylene-styrene-divinylbenzene terpolymer. The “polyolefin other than the ethylene-styrene-divinylbenzene terpolymer” may comprise, for example, vinyl-containing polyolefin or hydrogenated polyolefin, but the present invention is not limited thereto. The types of the “vinyl-containing polyolefin” is not particularly limited, and may comprise various vinyl-containing olefin polymers other than the ethylene-styrene-divinylbenzene terpolymer known in the art. For example, the vinyl-containing polyolefin may comprise, but are not limited to polybutadiene, polyisoprene, styrene-butadiene copolymer, styrene-isoprene copolymer, styrene-butadiene-divinylbenzene terpolymer, butadiene-styrene copolymer adducted with maleic anhydride, vinyl-polybutadiene-urea ester oligomer, or polybutadiene adducted with maleic anhydride. The types of the “hydrogenated polyolefin” are not particularly limited, and may comprise various hydrogenated styrene-butadiene-styrene block copolymers (also called as styrene-ethylene/butylene-styrene copolymer) known in the art. The hydrogenated polyolefin suitable for use in the present invention may be any one or more commercially available products or homemade products. For example, the hydrogenated polyolefin may comprise, but is not limited to hydrogenated styrene-butadiene-styrene block copolymer or hydrogenated styrene-butadiene-styrene block copolymer substituted with maleic anhydride. That is, the hydrogenated polyolefin may comprise, but is not limited to unsubstituted hydrogenated styrene-butadiene-styrene triblock copolymer or hydrogenated styrene-butadiene-styrene triblock copolymers substituted with maleic anhydride. For example, the hydrogenated polyolefin may comprise, but is not limited to hydrogenated polyolefin produced by Asahi KASEI Corporation with the trade names H1221, H1062, H1521, H1052, H1041, H1053, H1051, H1517, H1043, N504, H1272, M1943, M1911 or M1913, hydrogenated polyolefin produced by KRATON company with trade names G1650, G1651, G1652, G1654, G1657, G1726, FG1901 or FG1924, or hydrogenated polyolefin produced by Kuraray Company with trade names 8004, 8006 or 8007L.

In one embodiment, when the resin composition comprises polyolefin other than the ethylene-styrene-divinylbenzene terpolymer, the content of the polyolefin other than the ethylene-styrene-divinylbenzene terpolymer may be 5 parts by weight to 50 parts by weight, for example, 6 parts by weight to 48 parts by weight or 10 parts by weight to 20 parts by weight. However, the present invention is not limited thereto, and the content of the polyolefin other than the ethylene-styrene-divinylbenzene terpolymer may be adjusted according to the needs.

In one embodiment, the resin composition may selectively further comprise vinyl-containing polyolefin other than the ethylene-styrene-divinylbenzene terpolymer. In another embodiment, with respect to 100 parts by weight of the vinyl-containing polyphenylene ether resin, the content of the vinyl-containing polyolefin may be 5 parts by weight to 20 parts by weight, but the present invention is not limited thereto. In further another embodiment, the resin composition may not comprise the vinyl-containing polyolefin other than ethylene-styrene-divinylbenzene terpolymer, and at this time, the content of the vinyl-containing polyolefin other than ethylene-styrene-divinylbenzene terpolymer is 0 parts by weight; here, it means that the vinyl-containing polyolefin other than ethylene-styrene-divinylbenzene terpolymer is not intentionally added into the resin composition.

In one embodiment, the resin composition may selectively further comprise hydrogenated polyolefin other than ethylene-styrene-divinylbenzene terpolymer. In another embodiment, with respect to 100 parts by weight of the vinyl-containing polyphenylene ether resin, the content of the hydrogenated polyolefin may be 6 parts by weight to 30 parts by weight, but the present invention is not limited thereto. In further another embodiment, the resin composition may not comprise the hydrogenated polyolefin other than ethylene-styrene-divinylbenzene terpolymer, and at this time, the content of the hydrogenated polyolefin other than ethylene-styrene-divinylbenzene terpolymer is 0 parts by weight; here, it means that the hydrogenated polyolefin other than ethylene-styrene-divinylbenzene terpolymer is not intentionally added into the resin composition.

In one embodiment, the resin composition may selectively further comprise acrylate. For example, the acrylates suitable for the present invention are not particularly limited. Any one or more acrylate compound containing two or more unsaturated bonds in the molecular structures are suitable, and may also include various commercially available monofunctional acrylate compounds. For example, acrylates used in the present invention include, but are not limited to, tricyclodecane di(meth)acrylate, tri(meth)acrylate, 1,1′-[(octahydro-4,7-methylene-1H-indene-5,6-diyl)bis(methylene)]ester (such as SR-833S, available from Sartomer) or a combination thereof.

In one embodiment, with respect to 100 parts by weight of the vinyl-containing polyphenylene ether resin, the resin composition may further comprise 1 part by weight to 5 parts by weight of the acrylate, for example, 1 part by weight to 3 parts by weight of the acrylate, but the present invention is not limited thereto. In one embodiment, the resin composition may not comprise the acrylate, and at this time, the content of the acrylate is 0 parts by weight; here, it means that the acrylate is not intentionally added into the resin composition. However, the present invention is not limited thereto, and the content of the acrylate may be adjusted according to the needs.

In one embodiment, the resin composition may selectively further comprise triallyl isocyanurate (also known as TAIC). In one embodiment, with respect to 100 parts by weight of the vinyl-containing polyphenylene ether resin, the resin composition may further comprise 3 parts by weight to 20 parts by weight of the triallyl isocyanurate, for example, 3 parts by weight to 15 parts by weight or 5 parts by weight to 15 parts by weight of the triallyl isocyanurate, but the present invention is not limited thereto. In another embodiment, the resin composition may not comprise the triallyl isocyanurate, and at this time, the content of the triallyl isocyanurate is 0 parts by weight; here, it means that the triallyl isocyanurate is not intentionally added into the resin composition. However, the present invention is not limited thereto, and the content of the triallyl isocyanurate may be adjusted according to the needs.

In one embodiment, the resin composition may selectively further comprise triallyl cyanurate. In one embodiment, the content of the triallyl cyanurate is not particularly limited. In another embodiment, the resin composition may not comprise the triallyl cyanurate, and at this time, the content of the triallyl cyanurate is 0 parts by weight; here, it means that the triallyl cyanurate is not intentionally added into the resin composition. However, the present invention is not limited thereto, and the content of the triallyl cyanurate may be adjusted according to the needs.

In one embodiment, the resin composition may selectively further comprise styrene maleic anhydride copolymer resin (referred to as styrene maleic anhydride resin). In one embodiment, in the styrene maleic anhydride copolymer resin, the ratio of styrene to maleic anhydride may be 1:1, 2:1, 3:1, 4:1, 6:1 or 8:1. Specific examples of the styrene maleic anhydride copolymer resin may comprise but are not limited to, styrene maleic anhydride copolymer available from Cray Valley with trade names SMA-1000, SMA-2000, SMA-3000, EF-30, EF-40, EF-60 or EF-80, or styrene maleic anhydride copolymer available from Polyscope with trade names C400, C500, C700 or C900. The styrene maleic anhydride resin may also be esterified styrene maleic anhydride copolymer, which may be, for example, the esterified styrene maleic anhydride copolymer available from Cray Valley with trade names SMA1440, SMA17352, SMA2625, SMA3840 or SMA31890. The styrene maleic anhydride resin may be added independently or in combination into the resin composition in one embodiment of the present invention.

In one embodiment, the content of the styrene maleic anhydride copolymer resin is not particularly limited. In one embodiment, the resin composition may not comprise the styrene maleic anhydride resin, and at this time, the content of the styrene maleic anhydride resin is 0 parts by weight. However, the present invention is not limited thereto, and the content of the styrene maleic anhydride resin may be adjusted according to the needs.

In one embodiment, the resin composition may further selectively comprise benzoxazine resin. In one embodiment, the benzoxazine resin may be, for example, bisphenol A type benzoxazine resin, bisphenol F type benzoxazine resin, phenolphthalein benzoxazine resin, dicyclopentadiene benzoxazine resin or phosphorus-containing benzoxazine resin. Specific examples of the benzoxazine resin may include, but are not limited to, LZ-827 (phenolphthalein benzoxazine resin), LZ-8280 (bisphenol F type benzoxazine resin) or LZ-8290 (bisphenol A type benzoxazine resin) available from Huntsman, or HFB-2006M available from Showa polymer co., Ltd.

In one embodiment, the content of the benzoxazine resin is not particularly limited. In one embodiment, the resin composition may not comprise the benzoxazine resin, and at this time, the content of the benzoxazine resin is 0 parts by weight. However, the present invention is not limited thereto, and the content of the benzoxazine resin may be adjusted according to the needs.

In one embodiment, the resin composition may selectively further comprise cyanate ester resin. In one embodiment, the cyanate ester resin may be any cyanate ester resin known in the art, wherein the cyanate ester resin may comprise, but are not limited to cyanate ester resin with Ar—O—C≡N structure (wherein, Ar is an aryl group such as phenyl, naphthyl or anthracenyl), phenol novolac cyanate ester resin, bisphenol A type cyanate ester resin, bisphenol A novolac cyanate ester resin, bisphenol F type cyanate ester resin, bisphenol F novolac cyanate ester resin, dicyclopentadiene-containing cyanate ester resin, naphthalene-containing cyanate ester resin or phenolphthalein type cyanate ester resin. Specific examples of the cyanate ester resin may comprise, but are not limited to the cyanate ester resin available from Lonza with trade names Primaset PT-15, PT-30S, PT-60S, BA-200, BA-230S, BA-3000S, BTP-2500, BTP-6020S, DT-4000, DT-7000, ULL950S, HTL-300, CE-320, LVT-50 or LeCy.

In one embodiment, the content of the cyanate ester resin is not particularly limited. In another embodiment, the resin composition may not comprise the cyanate ester resin, and that is the content of the cyanate ester resin is 0 parts by weight. However, the present invention is not limited thereto, and the content of the cyanate ester resin may be adjusted according to the needs.

In one embodiment, the resin composition may selectively further comprise polysiloxane resin (hereinafter, referred to as polysiloxane). Specific examples of the polysiloxane may comprise, but are not limited to the polysiloxane produced by Shin-Etsu Corporation with trade names X-22-161A, X-22-161B, X-22-163A, X-22-163B or X-22-164. In one embodiment, the content of the polysiloxane is not particularly limited. In another embodiment, the resin composition may not comprise the polysiloxane, and at this time, the content of the polysiloxane is 0 parts by weight; here, it means that the polysiloxane is not intentionally added into the resin composition. However, the present invention is not limited thereto, and the content of the polysiloxane may be adjusted according to the needs.

In one embodiment, the resin composition may further comprise an inorganic filler, an inhibitor, a flame retardant, a colorant, a toughener, a core-shell rubber, a silane coupling agent, a solvent or a combination thereof. The aforesaid components may be used alone or in combination.

In one embodiment, the resin composition may selectively further comprise an inorganic filler, and the content of the inorganic filler is not limited. In another embodiment, with respect to 100 parts by weight of the vinyl-containing polyphenylene ether resin, the resin composition may further comprise 20 parts by weight to 380 parts by weight of the inorganic filler, 60 parts by weight to 240 parts by weight of the inorganic filler or 160 parts by weight to 360 parts by weight of the inorganic filler. However, the present invention is not limited thereto, and the content of the inorganic filler may be adjusted according to the needs.

In one embodiment, the inorganic filler may be silica. In one embodiment, the inorganic filler may be spherical silica. The spherical silica may include various types of spherical silica known in the art, and the particle size distribution D50 of the spherical silica may be, for example, less than or equal to 2.0 μm. For example, the particle size distribution D50 of the spherical silica may preferably range from 0.2 μm to 2.0 μm, for example, but not limited to 0.2 μm, 0.3 μm, 0.4 μm, 0.6 μm, 0.8 μm, 1.2 μm, 1.3 μm or 2.0 μm. The particle size distribution D50 refers to the particle size corresponding to the cumulative volume distribution of fillers (such as but not limited to spherical silica) reaching 50% as measured by laser scattering. The spherical silica suitable for the present invention is not particularly limited, and may be any one or more commercially available products, such as but not limited to spherical silica purchased from Admatechs Company.

In one embodiment, with respect to 100 parts by weight of the vinyl-containing polyphenylene ether resin, the inorganic filler may comprise 120 parts by weight to 360 parts by weight of the spherical silica, 160 parts by weight to 360 parts by weight of the spherical silica or 240 parts by weight to 360 parts by weight of the spherical silica. However, the present invention is not limited thereto, and the content of the spherical silica may be adjusted according to the needs.

In one embodiment, the spherical silica may optionally be pretreated with siloxane if it is needed. Siloxane may comprise amino silane, epoxy silane, vinyl silane, ester silane, hydroxysilane, isocyanurate silane, methacryloxysilane or acryloxysilane. With respect to 100 parts by weight of the spherical silica, the amount of the aforesaid silane for pretreatment may range from 0.005 parts by weight to 0.5 parts by weight, but the present invention is not limited thereto. The amount of the silane is not particularly limited, and the adding amount of the silane may be adjusted according to the dispersion of the inorganic filler in the resin composition.

In one embodiment, the inorganic filler in the resin composition may be an inorganic filler other than spherical silica. In one embodiment, the inorganic filler other than the spherical silica may comprise, but are not limited to, non-spherical silica (that is, the known irregular type silica, and the irregular type silica is not spherical silica), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate modified talc, zinc oxide, zirconia, mica, boehmite (AlOOH), calcined talc, talc, silicon nitride or calcined kaolin.

In addition, except for the aforementioned non-spherical silica, the rest of the aforementioned inorganic fillers different from the spherical silica can be spherical, fibrous, plate-like, granular, flake-like, needle-like or whisker-like. The inorganic fillers other than the spherical silica may selectively be pretreated with siloxane. The examples and amount of the siloxane used to pretreat the inorganic fillers are as mentioned above, and are not repeated here.

In one embodiment, with respect to 100 parts by weight of the vinyl-containing polyphenylene ether resin, the inorganic filler may comprise 10 parts by weight to 50 parts by weight of the inorganic filler other than the spherical silica or 10 parts by weight to 30 parts by weight of the inorganic filler other than the spherical silica; but the present invention is not limited thereto. In one embodiment, with respect to 100 parts by weight of the vinyl-containing polyphenylene ether resin, the inorganic filler may comprise 10 parts by weight to 30 parts by weight of boron nitride.

In one embodiment, the resin composition may selectively further comprise an inhibitor. The inhibitor in the resin composition may be any one or more inhibitors suitable for making prepregs, resin films, laminates or printed circuit boards. The inhibitor may include various molecular polymerization inhibitors or stable free radical polymerization inhibitors known in the art. The molecular polymerization inhibitors may include, but are not limited to, phenolic compounds, quinone compounds, aromatic amine compounds, aromatic hydrocarbon nitro compounds, sulfur-containing compounds, variable-valent metal chlorides, or a combination thereof. More specifically, the molecular polymerization inhibitors may include, but are not limited to, phenol, hydroquinone, 4-tert-butylcatechol, benzoquinone, chloranil, 1,4-naphthoquinone, trimethylquinone, aniline, nitrobenzene, Na₂S, FeCl₃, CuCl₂ or a combination thereof. For example, the stable free radical polymerization inhibitors may include, but are not limited to, 1,1-diphenyl-2-trinitrophenylhydrazine (DPPH), triphenylmethyl free radical, 2,2,6,6-tetramethyl piperidine-1-oxide, derivatives of 2,2,6,6-tetramethylpiperidine-1-oxide, or a combination thereof.

In one embodiment, the content of the inhibitor is not particularly limited. In another embodiment, with respect to 100 parts by weight of the vinyl-containing polyphenylene ether resin, the resin composition may further comprise 0.01 parts by weight to 0.5 parts by weight of the inhibitor, and for example, 0.02 parts by weight, 0.05 parts by weight, 0.2 parts by weight, 0.3 parts by weight, 0.45 parts by weight or 0.5 parts by weight of the inhibitor. However, the present invention is not limited thereto, and the content of the inhibitor may be adjusted according to the needs. In further another embodiment, the resin composition may not comprise an inhibitor, and at this time, the content of the inhibitor is 0 parts by weight; here, it means that the inhibitor is not intentionally added into the resin composition.

In one embodiment, the resin composition may selectively further comprise a flame retardant. The flame retardant in the resin composition may be any one or more flame retardants suitable for making prepregs, resin films, laminates or printed circuit boards, such as but not limited to phosphorus-containing flame retardants. For example, the phosphorus-containing flame retardants may comprise: ammonium polyphosphate, hydroquinone bis-(diphenyl phosphate), bisphenol A bis-(diphenylphosphate), tri(2-carboxyethyl) phosphine (TCEP), tris(chloroisopropyl)phosphate, trimethyl phosphate (TMP), dimethyl methyl phosphonate (DNIP), resorcinol bis(dixylenyl phosphate), RDXP (such as commercially available products PX-200, PX-201 or PX-202), phosphazene (such as commercially available products SPB-100, SPH-100 or SPV-100), melamine polyphosphate, 9,10-dihydro-9-oxa-10-phosphaphenanthrene-10-oxide (DOPO) or derivatives thereof (such as di-DOPO compound) or resin thereof (such as DOPO-HQ, DOPO-NQ, DOPO-PN or DOPO-BPN), DOPO-bonding epoxy, diphenylphosphine oxide (DPPO) or derivatives thereof (such as di-DPPO compound) or resin thereof, melamine cyanurate, tri-hydroxyethyl isocyanurate, or aluminum phosphinate (such as commercially available products OP-930 or OP-935). Herein, DOPO-PN is DOPO phenol novolak resin, and DOPO-BPN may be DOPO bisphenol novolac resin such as DOPO-BPAN (DOPO-bisphenol A novolac), DOPO-BPFN (DOPO-bisphenol F novolac) or DOPO-BPSN (DOPO-bisphenol S novolac).

In one embodiment, when the resin composition comprises a flame retardant, the content of the flame retardant may be 30 parts by weight to 90 parts by weight, for example, may be 30 parts by weight, 40 parts by weight, 50 parts by weight, 60 parts by weight, 70 parts by weight, 80 parts by weight or 90 parts by weight. However, the present invention is not limited thereto, and the content of the flame retardant may be adjusted according to the needs. In another embodiment, the resin composition may not comprise the flame retardant, and at this time, the content of the flame retardant is 0 parts by weight; here, it means that the flame retardant is not intentionally added into the resin composition.

In one embodiment, the resin composition may selectively further comprise a colorant, a toughener, a core-shell rubber or a combination thereof. The colorant suitable for use in the present invention may include, but is not limited to, dyes or pigments. The main function of the toughener is to improve the toughness of the resin composition. The toughener suitable for the present invention may include, but are not limited to, carboxyl-terminated butadiene acrylonitrile rubber (CTBN) and other rubbers. The core-shell rubber suitable for the present invention may include various commercially available core-shell rubbers.

In one embodiment, the content of the colorant, the toughener or the core-shell rubber may respectively be 0.01 parts by weight to 10 parts by weight, for example, but are not limited to 0.01 parts by weight to 3 parts by weight or 0.05 parts by weight to 1 part by weight. However, the present invention is not limited thereto, and the contents of the aforesaid components may be adjusted according to the needs.

In one embodiment, the resin composition may selectively further comprise a silane coupling agent. For example, the silane coupling agent may comprise a silane (for example, but not limited to siloxane). According to the type of functional groups, the silane can be divided into amino silane, epoxide silane, vinyl silane, acrylate silane, methacrylate silane, hydroxysilane, isocyanurate silane, methacryloxysilane or acryloxysilane.

In one embodiment, the resin composition may selectively further comprise a solvent. The main function of adding solvent is to dissolve the components in the resin composition, change the solid content of the resin composition, and adjust the viscosity of the resin composition. Examples of the solvent include, but are not limited to, methanol, ethanol, ethylene glycol monomethyl ether, acetone, butanone (also known as methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, dimethylformamide, dimethylacetamide, nitromethylpyrrolidone or a combination thereof.

In the present invention, the adding amount of the solvent is not particularly limited, and may be adjusted according to the desired viscosity of the resin composition. If a solvent is added to the resin composition, the solvent will evaporate and be removed when the resin composition is heated to a high temperature to form a semi-cured state. Therefore, there is no solvent in the prepreg or the resin film, or there is only a trace amount of solvent in the prepreg or the resin film.

In one embodiment, the resin composition may further comprise a reaction initiator. The reaction initiator may be, for example, peroxides or carbon-carbon initiators. Herein, specific examples of the peroxides may include, but are not limited to, 2,5-dimethyl-2,5-bis(tert-butylperoxy)-3-hexyne, dicumyl peroxide or a combination thereof. Herein, specific examples of the carbon-carbon initiators may include, but are not limited to, 2,3-dimethyl-2,3-diphenylbutane. In one embodiment, with respect to 100 parts by weight of the vinyl-containing polyphenylene ether resin, the resin composition may further comprise 0.01 parts by weight to 20 parts by weight of the reaction initiator, and for example, 0.02 parts by weight to 0.92 parts by weight or 0.4 parts by weight to 0.9 parts by weight of the reaction initiator, but the present invention is not limited thereto. In one embodiment, with respect to 100 parts by weight of the vinyl-containing polyphenylene ether resin, the resin composition may further comprise 1 part by weight to 20 parts by weight of 2,3-dimethyl-2,3-diphenylbutane, but the present invention is not limited thereto.

The resin composition according to one embodiment of the present invention can be made into various products through various processing methods, including but not limited to prepregs, resin films, laminates or printed circuit boards.

For example, the resin composition provided by one embodiment the present invention can be used to prepare a prepreg, which may include a reinforcing material and a layered structure disposed thereon. The layered structure may be formed by heating the aforementioned resin composition to a high temperature to form a semi-cured state (B-stage). The baking temperature for preparing the prepreg may be between 120° C. and 180° C., and preferably between 130° C. and 150° C. The baking time may be 3 minutes to 6 minutes. The reinforcing material may be any one of fiber material, woven fabric, and non-woven fabric, and the woven fabric preferably includes glass fiber fabric. The type of the glass fiber fabric is not particularly limited, and can be various commercially available glass fiber fabrics that can be used for printed circuit boards, such as E-type glass fiber fabric, D-type glass fiber fabric, S-type glass fiber fabric, T-type glass fiber fabric, L-type glass fiber fabric or Q-type quartz fiber fabric, wherein the types of fibers may include yarn or roving, and the form may include spread form or standard form. The non-woven fabric preferably includes liquid crystal resin non-woven fabric or quartz non-woven fabric. The liquid crystal resin non-woven fabric may be, for example, polyester non-woven fabric, polyurethane non-woven fabric, etc., and is not limited thereto. The woven fabric may also include liquid crystal resin woven fabric, such as polyester woven fabric or polyurethane woven fabric, and is not limited thereto. The reinforcing material can increase the mechanical strength of the prepreg. In one preferred embodiment, the reinforcing material may also be selectively pretreated with a siloxane compound. After the prepreg is subsequently heated for curing (C-stage), an insulating layer can be formed.

For example, the resin composition of one embodiment of the present invention may be made into a resin film, which is obtained by heating and baking to semi-cure the resin composition. The resin composition may be selectively applied on a polyethylene terephthalate film (PET film), a polyimide film (PI film), a copper foil or a resin-coated copper foil, followed by heating and baking to semi-cure the resin composition to form a resin film.

For example, the resin composition of one embodiment of the present invention can be made into a laminate. For example, the laminate may include at least two metal foils and at least one insulating layer, the insulating layer is disposed between the two metal foils, and the insulating layer may be formed by laminating and curing the aforementioned resin composition at high temperature and under high pressure (C-stage). The suitable curing temperature may be, for example, between 200° C. and 240° C., and preferably between 210° C. and 230° C.; the curing time may be 120 minutes to 200 minutes, and preferably 140 minutes to 180 minutes; and the suitable pressure may be 400 psi to 600 psi, and preferably 450 psi to 550 psi. In one embodiment, the insulating layer may be obtained by curing at least one prepreg or at least one resin film. The metal foil can be made of copper, aluminum, nickel, platinum, silver, gold or alloys thereof. For example, the metal foil may be a copper foil. In a preferred embodiment, the laminate is a copper-clad laminate.

For example, the metal foil used in the laminate may be a hyper very low profile (HVLP) copper foil or a hyper very low profile 3 (HVLP3) copper foil. The matte side of the HVLP copper foil has a roughness Rz 2 (μm), and the matte side of the HVLP3 copper foil has a roughness Rz 1 (μm). The definition of the roughness Rz is the same as the general definition in the technical field of the copper foil, and is not repeated here.

For example, in one embodiment, the aforementioned laminate can be further processed into a printed circuit board after circuit processing, and the manufacturing method of the printed circuit board can be any known manufacturing method.

For example, the article manufactured by the resin composition provided by one embodiment of the present invention has one, more or all of the following characteristics:
the copper foil peel strength of the copper-containing laminate measured by referring to the method described in IPC-TM-650 2.4.8 is greater than 3.00 lb/in;
T288 heat resistance measured by referring to the method described in IPC-TM-650 2.4.24.1 is greater than or equal to 130 minutes;
no explosion board is observed under the solder dipping heat resistance test when measuring by referring to the method described in IPC-TM-650 2.4.23;
the heat resistance test on the multilayer laminate is performed by the method described in IPC-TM-650 2.4.13.1, and the number of times without the board explosion is more than 20 times;
the glass transition temperature is greater than or equal to 200° C. measured by referring to the method described in IPC-TM-650 2.4.24.4;
the prepreg has a smooth appearance and no powder falling off when observed through visual inspection;
the appearance of the laminate is free of dryness and discoloration when observed through visual inspection; and
the water absorption rate measured after absorbing moisture for 3 hours through the pressure cooking test is less than or equal to 0.150% by referring to the method described in IPC-TM-650 2.6.16.1.

The chemical materials used in the following embodiments and comparative embodiments of the present invention are as follows.

SA9000: methacrylate-containing polyphenylene ether resin, commercially available.

OPE-2st 2200: vinylbenzyl biphenyl-containing polyphenylene ether resin, commercially available.

OPE-2st 1200: vinylbenzyl biphenyl-containing polyphenylene ether resin, commercially available.

The compound having the structure of formula (1): Synthesis Example 1.

Divinylbenzene: p-divinylbenzene, commercially available.

BMI-70: 3,3′-dimethyl-5,5′-diethyl-4,4′-diphenylmethane bismaleimide, commercially available.

BMI-80: bisphenol A diphenyl ether bismaleimide, commercially available.

SLK-3000: maleimide containing C10-50 aliphatic structure, purchased from Shin-etsu Chemical.

Ethylene-styrene-divinylbenzene terpolymer: terpolymer of divinylbenzene, styrene and ethylene; in the polymerization raw materials of the ethylene-styrene-divinylbenzene terpolymer, the content of the ethylene is 70 mol % to 80 mol %, the content of the styrene is 20 mol % to 30 mol %, the content of the divinylbenzene is 0.01 mol % to 1 mol %, and the total amount of the divinylbenzene, the styrene and the ethylene is 100 mol %; and the number average molecular weight of the ethylene-styrene-divinylbenzene terpolymer ranges from 5,000 to 15,000; commercially available.

Divinylbenzene-styrene-ethylstyrene terpolymer: Synthesis Example 2.

Ricon 257: styrene-butadiene-divinylbenzene terpolymer, commercially available.

Ricon 100: styrene-butadiene copolymer, commercially available.

Ricon 181: styrene-butadiene copolymer, commercially available.

Ricon 150: polybutadiene, commercially available.

D1118: styrene-butadiene-styrene terpolymer, commercially available.

H1051: hydrogenated styrene-butadiene-styrene block copolymer, commercially available.

H1041: hydrogenated styrene-butadiene-styrene block copolymer, commercially available.

Polystyrene: commercially available.

TAIC: triallyl isocyanurate, commercially available.

SR-833S: 1,1′-[(octahydro-4,7-methylene-1H-indene-5,6-diyl)bis(methylene)]ester, commercially available.

25B: 2,5-dimethyl-2,5-bis(tertiary butylperoxy)-3-hexyne, commercially available.

DCP: dicumyl peroxide, commercially available.

SC2050 SMJ: spherical silica, commercially available.

SC2050 SVJ: spherical silica, commercially available.

CFP007ST: hexagonal boron nitride (h-BN), purchased from 3M Company.

Butanone and toluene: commercially available.

### Synthesis Example 1: Preparation of the Compound Having the Structure of Formula (1)

296 parts by weight of 2-bromoethylbenzene (manufactured by Tokyo Chemical Industry Co., Ltd.), 70 parts by weight of α,α′-dichloro-p-xylene (manufactured by Tokyo Chemical Industry Co., Ltd.) and 18.4 parts by weight of methanesulfonic acid (manufactured by Tokyo Chemical Industry Co., Ltd.) were mixed. After reacting at 130° C. for 8 hours, it was cooled to room temperature, neutralized with a sodium hydroxide aqueous solution, and extracted with 1,200 parts by weight of toluene. The organic layer was washed with water. The solvent and excess 2-bromoethylbenzene was distilled off under heating and reduced pressure to obtain an intermediate product. The molar ratio of 2-bromoethylbenzene to α,α′-dichloro-p-xylene may be 4:1. Methanesulfonic acid was used as an acidic catalyst and may be replaced by other acidic catalysts such as hydrochloric acid or phosphoric acid. The reaction conditions may be 40° C. to 180° C. and 0.5 hours to 20 hours.

22 parts by weight of the above-mentioned intermediate product, 50 parts by weight of toluene (other aromatic solvents, such as xylene, may also be used), 150 parts by weight of dimethyl sulfoxide (other aprotic polarity solvent may also be used, such as dimethyl sulfone), 15 parts by weight of water and 5.4 parts by weight of sodium hydroxide (other alkaline catalysts may also be used, such as potassium hydroxide or potassium carbonate) were react at 40° C. for 5 hours, then cooled to room temperature. 100 parts by weight of toluene was added. The organic layer was washed with water, and the solvent was distilled off under heating and reduced pressure to obtain the compound having the structure of formula (1), wherein n is an integer from 1 to 20.

### Synthesis Example 2: Preparation of Divinylbenzene-Styrene-Ethylstyrene Terpolymer

3.0 moles (390.6 grams) of divinylbenzene, 1.8 moles (229.4 grams) of ethylvinylbenzene, 10.2 moles (1066.3 grams) of styrene and 15.0 moles (1532.0 g) of n-propyl acetate were added into a reactor to obtain a polymerization solution. The polymerization solution was continuously stirred to mix evenly, the temperature of the polymerization solution was raised to 70° C., and 600 millimoles of boron trifluoride-diethyl ether complex was added to the polymerization solution. The polymerization solution was continuously stirred to continue the polymerization reaction for 4 hours. Then, sodium bicarbonate aqueous solution was added to terminate the polymerization reaction. The oil layer was washed three times with pure water, and the volatile components were removed under reduced pressure at 60° C. to obtain divinylbenzene-styrene-ethylstyrene terpolymer.

The resin compositions of Embodiments and Comparative embodiments of the present invention were prepared according to the amounts of the above-mentioned various raw materials listed in Table 1 to Table 3 below, and further prepared into various test samples.

TABLE 1
The components of the resin composition of Embodiments E1 to E6 (unit: parts by weight)

| Material | Component | Name | E1 | E2 | E3 | E4 | E5 | E6 |
|---|---|---|---|---|---|---|---|---|
| Vinyl- | Methacrylate-containing | SA9000 | 100 | 100 | 100 | 60 | 60 | 70 |
| containing | polyphenylene ether resin | | | | | | | |
| polyphenylene | Vinylbenzyl group-containing | OPE-2st 2200 | | | | 20 | 30 | 25 |
| ether | polyphenylene ether resin | OPE-2st 1200 | | | | 20 | 10 | 5 |
| Vinylbenzyl- | Compound of formula (1) | | 40 | 20 | 60 | 30 | 50 | 25 |
| containing | Divinylbenzene | | | | | | | |
| compound | | | | | | | | |
| Maleimide resin | Aromatic maleimide resin | BMI-70 | | | | | | 5 |
| | | BMI-80 | | | | | | |
| | Aliphatic maleimide resin | SLK-3000 | | | | | 6 | |
| Divinylbenzene- | Ethylene-styrene-divinylbenzene | | 40 | 60 | 30 | 24 | 50 | 20 |
| containing | terpolymer | | | | | | | |
| copolymer | Divinylbenzene-styrene-ethylstyrene | | | | | | | |
| | terpolymer | | | | | | | |
| | Styrene-butadiene- | Ricon 257 | | | | 8 | | |
| | divinylbenzene | | | | | | | |
| | terpolymer | | | | | | | |
| Polyolefin | Styrene-butadiene | Ricon 100 | | | | | 6 | |
| | copolymer | | | | | | | |
| | Styrene-butadiene | Ricon 181 | | | | | | |
| | copolymer | | | | | | | |
| | Polybutadiene | Ricon 150 | | | | | 6 | |
| | Styrene-butadiene- | D1118 | | | | | 6 | |
| | styrene terpolymer | | | | | | | |
| | Hydrogenated styrene- | H1051 | 20 | 20 | 10 | | 24 | 10 |
| | butadiene-styrene block | | | | | | | |
| | copolymer | | | | | | | |
| | Hydrogenated styrene- | H1041 | | | | | 6 | 5 |
| | butadiene-styrene block | | | | | | | |
| | copolymer | | | | | | | |
| Polystyrene | Polystyrene | | | | | | | |
| Additive | Triallyl isocyanurate | TAIC | | | | | 10 | |
| | Acrylate | SR-833S | | | | | 2 | |
| Reaction | Peroxide | 25B | 0.6 | 0.7 | 0.5 | 0.4 | 0.9 | 0.6 |
| initiator | | DCP | | | | | 0.02 | |
| Inorganic filler | Spherical silica | SC2050 SMJ | 240 | 240 | 240 | 160 | 300 | 180 |
| | | SC2050 SVJ | | | | | 60 | |
| | Hexagonal boron nitride | CFP007ST | | | | | 20 | |

| | | | | | | | |
|---|---|---|---|---|---|---|---|
| Solvent | Butanone | 20 | 20 | 20 | 10 | 50 | 10 |
| | Toluene | 300 | 300 | 300 | 250 | 400 | 250 |

| | | | | | | | |
|---|---|---|---|---|---|---|---|
| Characteristics | Unit | E1 | E2 | E3 | E4 | E5 | E6 |
| P/S | lb/in | 3.45 | 3.55 | 3.41 | 3.58 | 3.52 | 3.56 |
| T288 | min | >130 | >130 | >130 | >130 | >130 | >130 |
| S/D | — | OK | OK | OK | OK | OK | OK |
| Heat resistance of laminates | Times | >20 | >20 | >20 | >20 | >20 | >20 |
| Glass transition temperature | ° C. | 223 | 210 | 230 | 224 | 218 | 226 |
| Appearance of prepreg | — | OK | OK | OK | OK | OK | OK |
| Appearance of copper-free laminate | — | OK | OK | OK | OK | OK | OK |
| PCT water absorption rate | % | 0.122 | 0.128 | 0.125 | 0.121 | 0.116 | 0.118 |

TABLE 2
The components of the resin composition of Comparative Embodiments C1 to C5 (unit: parts by weight)

| Material | Component | Name | C1 | C2 | C3 | C4 | C5 |
|---|---|---|---|---|---|---|---|
| Vinyl- | Methacrylate-containing | SA9000 | 100 | 100 | 100 | 180 | 100 |
| containing | polyphenylene ether resin | | | | | | |
| polyphenylene | Vinylbenzyl group-containing | OPE-2st 2200 | | | | | |
| ether | polyphenylene ether resin | OPE-2st 1200 | | | | | |
| Vinylbenzyl- | Compound of formula (1) | | | 40 | | | |
| containing | | | | | | | |
| compound | Divinylbenzene | | 40 | | | | 20 |
| Maleimide resin | Aromatic maleimide resin | BMI-70 | | | 40 | | |
| | | BMI-80 | | | | | 20 |
| | Aliphatic maleimide resin | SLK-3000 | | | | | |
| Divinylbenzene- | Ethylene-styrene-divinylbenzene | | 40 | | 40 | | |
| containing | terpolymer | | | | | | |
| copolymer | Divinylbenzene-styrene-ethylstyrene | | | 40 | | | |
| | terpolymer | | | | | | |
| | Styrene-butadiene- | Ricon 257 | | | | | 40 |
| | divinylbenzene terpolymer | | | | | | |
| Polyolefin | Styrene-butadiene copolymer | Ricon 100 | | | | | |
| | Styrene-butadiene copolymer | Ricon 181 | | | | | |
| | Polybutadiene | Ricon 150 | | | | | |
| | Styrene-butadiene- | D1118 | | | | | |
| | styrene terpolymer | | | | | | |
| | Hydrogenated | H1051 | 20 | 20 | 20 | 20 | 20 |
| | styrene-butadiene- | | | | | | |
| | styrene block copolymer | | | | | | |
| | Hydrogenated styrene- | H1041 | | | | | |
| | butadiene-styrene | | | | | | |
| | block copolymer | | | | | | |
| Polystyrene | Polystyrene | | | | | | |
| Additive | Triallyl isocyanurate | TAIC | | | | | |
| | Acrylate | SR-833S | | | | | |
| Reaction | Peroxide | 25B | 0.6 | 0.6 | 0.6 | 0.6 | 0.6 |
| initiator | | DCP | | | | | |
| Inorganic | Spherical silica | SC2050 SMJ | 240 | 240 | 240 | 240 | 240 |
| filler | | SC2050 SVJ | | | | | |
| | Hexagonal boron | CFP007ST | | | | | |
| | nitride | | | | | | |

| | | | | | | |
|---|---|---|---|---|---|---|
| Solvent | Butanone | 20 | 20 | 120 | 20 | 160 |
| | Toluene | 300 | 300 | 200 | 300 | 240 |

| | | | | | | |
|---|---|---|---|---|---|---|
| Characteristics | Unit | C1 | C2 | C3 | C4 | C5 |
| P/S | lb/in | 2.58 | 2.95 | 3.33 | 4.02 | 2.19 |
| T288 | min | 85 | 28 | >130 | >130 | 32 |
| S/D | — | OK | NG | OK | OK | NG |
| Heat resistance of laminates | Times | Board | Board | Board | >20 | Board |
| | | exploded | exploded | exploded | | exploded |
| | | after 10 | after 5 | after 15 | | after 5 |
| | | times | times | times | | times |
| Glass transition temperature | ° C. | 220 | 232 | 196 | 188 | 202 |
| Appearance of prepreg | — | OK | OK | OK | NG | OK |
| Appearance of copper-free laminate | — | OK | NG | OK | OK | NG |
| PCT water absorption rate | % | 0.164 | 0.163 | 0.356 | 0.325 | 0.399 |

TABLE 3
The components of the resin composition of Comparative Embodiments C6 to C11 (unit: parts by weight)

| Material | Component | Name | C6 | C7 | C8 | C9 | C10 | C11 |
|---|---|---|---|---|---|---|---|---|
| Vinyl- | Methacrylate-containing | SA9000 | 100 | 100 | 100 | 100 | 100 | 100 |
| containing | polyphenylene ether resin | | | | | | | |
| polyphenyl | Vinylbenzyl group-containing | OPE-2st 2200 | | | | | | |
| ene ether | polyphenylene ether resin | OPE-2st 1200 | | | | | | |
| Vinyl | Compound of formula (1) | | | 40 | 40 | 40 | 80 | |
| benzyl- | | | | | | | | |
| containing | Divinylbenzene | | 50 | | | | | |
| compound | | | | | | | | |
| Maleimide | Aromatic maleimide resin | BMI-70 | | | | | | |
| resin | | BMI-80 | | | | | | |
| | Aliphatic maleimide resin | SLK-3000 | | | | | | |
| Divinyl | Ethylene-styrene- | | | | | | | 80 |
| benzene- | divinylbenzene terpolymer | | | | | | | |
| containing | Divinylbenzene-styrene- | | | | | | | |
| copolymer | ethylstyrene terpolymer | | | | | | | |
| | Styrene-butadiene- | Ricon 257 | | 40 | | | | |
| | divinylbenzene terpolymer | | | | | | | |
| Polyolefin | Styrene-butadiene copolymer | Ricon 100 | | | | | | |
| | Styrene-butadiene copolymer | Ricon 181 | | | | 60 | | |
| | Polybutadiene | Ricon 150 | | | | | | |
| | Styrene-butadiene-styrene | D1118 | | | | | | |
| | terpolymer | | | | | | | |
| | Hydrogenated styrene- | H1051 | 20 | 20 | 60 | | 20 | 20 |
| | butadiene-styrene | | | | | | | |
| | block copolymer | | | | | | | |
| | Hydrogenated styrene- | H1041 | | | | | | |
| | butadiene-styrene | | | | | | | |
| | block copolymer | | | | | | | |
| Polystyrene | Polystyrene | | 30 | | | | | |
| Additive | Triallyl isocyanurate | TAIC | | | | | | |
| | Acrylate | SR-833S | | | | | | |
| Reaction | Peroxide | 25B | 0.6 | 0.6 | 0.6 | 0.6 | 0.6 | 0.6 |
| initiator | | DCP | | | | | | |
| Inorganic | Spherical silica | SC2050 SMJ | 240 | 240 | 240 | 240 | 240 | 240 |
| filler | | SC2050 SVJ | | | | | | |
| | Hexagonal boron nitride | CFP007ST | | | | | | |

| | | | | | | | |
|---|---|---|---|---|---|---|---|
| Solvent | Butanone | 20 | 20 | 20 | 20 | 20 | 20 |
| | Toluene | 300 | 300 | 300 | 300 | 300 | 300 |

| | | | | | | | |
|---|---|---|---|---|---|---|---|
| Characteristics | Unit | C6 | C7 | C8 | C9 | C10 | C11 |
| P/S | lb/in | 2.76 | 2.64 | 2.68 | 2.61 | 2.24 | 3.02 |
| T288 | min | 69 | >130 | 74 | 58 | 94 | 45 |
| S/D | — | NG | OK | NG | NG | OK | OK |
| Heat resistance of laminates | Times | Board | Board | Board | Board | Board | Board |
| | | exploded | exploded | exploded | exploded | exploded | exploded |
| | | after 5 | after 15 | after 10 | after 10 | after 15 | after 5 |
| | | times | times | times | times | times | times |
| Glass transition temperature | ° C. | 195 | 203 | 215 | 205 | 242 | 182 |
| Appearance of prepreg | — | OK | OK | OK | OK | OK | OK |
| Appearance of copper-free laminate | — | OK | OK | OK | OK | OK | OK |
| PCT water absorption rate | % | 0.215 | 0.261 | 0.168 | 0.185 | 0.159 | 0.146 |

### Varnish

According to the amounts shown Table 1 to Table 3, the components of each Embodiments (abbreviated as E, such as E1 to E6) and Comparative embodiments (abbreviated as C, such as C1 to C11) were respectively added into the stirring tank and stirred. After mixing uniformly, the obtained resin composition was called as a varnish.

The formulation method of the resin composition of Embodiment 1 (E1) is used as an example. 100 parts by weight of SA9000 and 40 parts by weight of ethylene-styrene-divinylbenzene terpolymer were added into a stirrer containing 20 parts by weight of butanone solvent and 300 parts by weight of toluene solvent, followed by stirring until SA9000 was completely dissolved and mixed evenly. Then, 40 parts by weight of the compound of formula (1) and 20 parts by weight of H1051 were added and stirred until they were completely dissolved and mixed evenly. Then, 240 parts by weight of SC-2050 SMJ and 0.6 parts by weight of 25B were added and continuously stirred to mix evenly to obtain the varnish of the resin composition of Embodiment E1.

In addition, according to the amounts shown in Table 1 to Table 3, the varnishes of the resin compositions of Embodiments 2 to 6 (E2 to E6) and Comparative embodiments 1 to 11 (C1 to C11) were prepared with reference to the preparation method of the varnish of Embodiment 1 (E1).

With reference to the following methods, the varnishes of Embodiments 1 to 6 (E1 to E6) and Comparative embodiments 1 to 11 (C1 to C11) were used to prepare the samples (respectively including prepregs, copper-containing laminates and copper-free laminates) to be tested. Then, the characteristic analyses were performed according to the following specific conditions.

### Prepreg 1 (Using 2116 E-Glass Fiber Fabric)

The resin compositions in different Embodiments (E1 to E6) and Comparative embodiments (C1 to C11) listed in Table 1 to Table 3 were respectively put into an impregnation tank in batches. The glass fiber fabric (such as 2116 E-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 1 (the resin content is about 58%).

### Prepreg 2 (Using 1080 L-Glass Fiber Fabric)

The resin compositions in different Embodiments (E1 to E6) and Comparative embodiments (C1 to C11) listed in Table 1 to Table 3 were respectively put into an impregnation tank in batches. The glass fiber fabric (such as 1080 L-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 2 (the resin content is about 70%).

Copper-Containing Laminate (or Called as Copper-Clad Laminate, which is Prepared by Laminating Eight Prepregs 1)

Two hyper very low profile 3 (HVLP3) copper foils with a thickness of 18 μm and the same eight aforementioned prepregs 1 were provided. One copper foil, eight prepregs 1 and one copper foil were laminated in sequence, and the lamination was performed under a vacuum condition at 500 psi and 220° C. for 150 minutes to obtain a copper-containing laminate.

Copper-Free Laminate (which is Prepared by Laminating Eight Prepregs 1)

The aforesaid copper-containing laminate was etched to remove the copper foils on both sides to obtain a copper-free laminate, which is formed by laminating eight prepregs 1.

The test methods and characteristic analysis items for the aforementioned samples to be tested are explained as follows.

### Copper Foil Peel Strength (P/S)

The copper-containing laminate (which was prepared by laminating eight prepregs 1) was cut into a rectangular sample with a width of 24 mm and a length greater than 60 mm, and the copper foil thereon was etched to leave a strip copper foil with a width of 3.18 mm and a length greater than 60 mm. According to the method described in IPC-TM-650 2.4.8, an universal tensile strength testing machine was used to measure the force required to pull the copper foil away from the surface of the laminate (unit: lb/inches, lb/in) at room temperature (about 25° C.). The higher the copper foil peel strength, the better. The difference between the copper foil peel strength values of different samples to be tested being greater than or equal to 0.20 lb/in represents a significant difference (there is significant technical difficulty). The copper foil peel strengths of the copper-containing laminates of Embodiments (E1 to E6) are all greater than 3.00 lb/in, for example, all greater than 3.41 lb/in, and for example, between 3.41 lb/in and 3.58 lb/in.

### T288 Heat Resistance

In the T288 heat resistance test, the above-mentioned copper-containing laminates (formed by laminating eight prepregs 1, with a length and width of 6.5 mm×6.5 mm) were used as the samples to be tested. A thermal mechanical analyzer (TMA) was to measure each sample to be tested at a constant temperature of 288° C. with reference to the method described in IPC-TM-650 2.4.24.1, and the board explosion time that the copper-containing laminates were exploded due to heat was recorded. The longer the board explosion time is, the higher the heat resistance of the copper-containing laminates produced using the resin composition is. If the test time exceeds 130 minutes without the board explosion, it will be marked as “>130”, which means that the sample to be test is not exploded after more than 130 minutes under the T288 heat resistance test.

For example, the time that the products made using the resin compositions of the present invention are not exploded is greater than or equal to 130 minutes, for example, between 30 minutes to 150 minutes, and for example, between 130 minutes to 140 minutes.

### Solder Dipping (S/D) Heat Resistance

The copper-containing laminate (which was prepared by laminating eight prepregs 1) was used as the sample to be tested, which was cut into a sheet with a length of 20 cm and a width of 10 cm. Referring to the method described in IPC-TM-650 2.4.23, the sample to be tested was immersed in a tin furnace with a constant temperature of 288° C., and taken out after immersing for 20 seconds to check whether there is any explosion. If the board is exploded, it will fail and be marked “NG”. If the board is not exploded, it will pass the test and be marked “OK”. For example, interlayer delamination between insulating layers is called board explosion. The interlayer delamination will cause blistering and separation between any layers of the laminate.

### Heat Resistance Test on the Multilayer Laminate

A core board was prepared according to the following method. Prepregs 1 were respectively provided which were prepared by impregnating 2116 E-glass fiber fabric with each sample to be tested (each of Embodiments or Comparative embodiments) (the resin content of each prepreg 1 is about 58%). Hyper very low profile 3 (HVLP3) copper foils (with the thickness of 18 μm) were respectively laminated on both sides of the prepreg 1, and then pressed and cured under vacuum, high temperature (220° C.) and high pressure (500 psi) for 2.5 hours, and a copper-containing core board was obtained. Next, the copper foils on both sides of the above-mentioned copper-containing core board were etched to obtain a copper-free core board (with the thickness of 5 mils). Three copper-free core boards were prepared according to the aforesaid methods. Next, two hyper very low profile 3 (HVLP3) copper foils (with the thickness of 18 μm) and eight prepregs 2 which were prepared by impregnating 1080 L-glass fiber fabric with each sample to be tested (each of Embodiments or Comparative embodiments) (the resin content of each prepreg 2 is about 70%) were provided. One copper foil, two prepregs 2 (prepared by using 1080 L-glass fiber fabric), one copper-free core board, two prepregs 2 (prepared using 1080 L-glass fiber fabric), one copper-free core board, two prepregs 2 (prepared using 1080 L-glass fiber fabric), one copper-free core board, two prepregs 2 (prepared using 1080 L-glass fiber fabric) and one copper foil were laminated in sequence, and the lamination was performed under a vacuum condition at 500 psi and 220° C. for 2.5 hours to obtain an eight-layer laminate with the outer layers being copper foils. The eight-layer laminate was cut into a rectangular sample with a length of 5.9 inches and a width of 2.2 inches. A total of 500 through holes with a diameter of 0.3 mm were formed on the surface of the rectangular sample using the circuit board drilling process (a 20×25 through hole matrix, wherein the vertical distance between adjacent hole walls is 0.25 mm). Electroplated copper was then formed on the hole walls to obtain a multilayer laminate sample for the heat resistance test.

In the heat resistance test of the multilayer laminate, the above multilayer laminate sample for the heat resistance test was used, and then the test was performed referring to the method described in IPC-TM-650 2.4.13.1. The sample was placed horizontally on (that is, contact) the tin liquid surface in a tin furnace with a constant temperature of 288° C. During each test, one side of the sample was placed on the tin surface for 10 seconds. After 10 seconds, the sample was removed from the tin surface and cooled at room temperature for 30 seconds. The same side of the sample was placed on the tin surface again for 10 seconds. After 10 seconds, the sample was taken out again and cooled at room temperature for 30 seconds. The sample is placed on the tin surface for 10 seconds and cooled at room temperature for 30 seconds, and the above steps are regarded as one time. The above steps were repeated to test the total number of times that each sample to be tested can withstand heat without board explosion. If the total number of tests exceeds 20 times and the board is still unexploded, it will be marked as “>20”. Generally, the greater the total number of times that each sample to be tested can be repeatedly subjected to the tin dipping heat resistance test without board explosion means that the heat resistance of the products (such as copper clad laminates) made by using the resin composition is better. The above-mentioned “board explosion” can be understood as interlayer peeling or blistering. Board explosion may occur between any layers of the laminate. For example, interlayer peeling between insulating layers can be called board explosion. For example, bubbling and separation between copper foil and insulating layers can also be called board explosion. Because the multilayer laminate contains multiple layers of copper foils and has been processed by the circuit board drilling process, the heat resistance test results thereof can truly reflect the heat resistance of the printed circuit board. The heat resistance test results of ordinary double-layer laminate without circuit board drilling process cannot accurately predict the heat resistance of multilayer laminates, that is, the heat resistance of printed circuit boards cannot be predicted.

### Glass Transition Temperature (Tg)

In the glass transition temperature test, the above-mentioned copper-free laminate (which is prepared by laminating eight prepregs) was used as the sample to be tested. The dynamic mechanical analysis (DMA) was used to measure the glass transition temperature (unit: ° C.) of the sample to be tested according to the method described in IPC-TM-650 2.4.24.4. The measurement temperature range was 35° C. to 270° C., and the temperature rising rate was 2° C./min. The higher the glass transition temperature, the better the properties. According to the results of the dynamic mechanical analysis, the glass transition temperature of the samples to be tested in Embodiments (E1 to E6) is greater than or equal to 200° C., which means that the copper-free laminate has the basic heat-resistant properties of the laminated.

### Appearance of the Prepreg

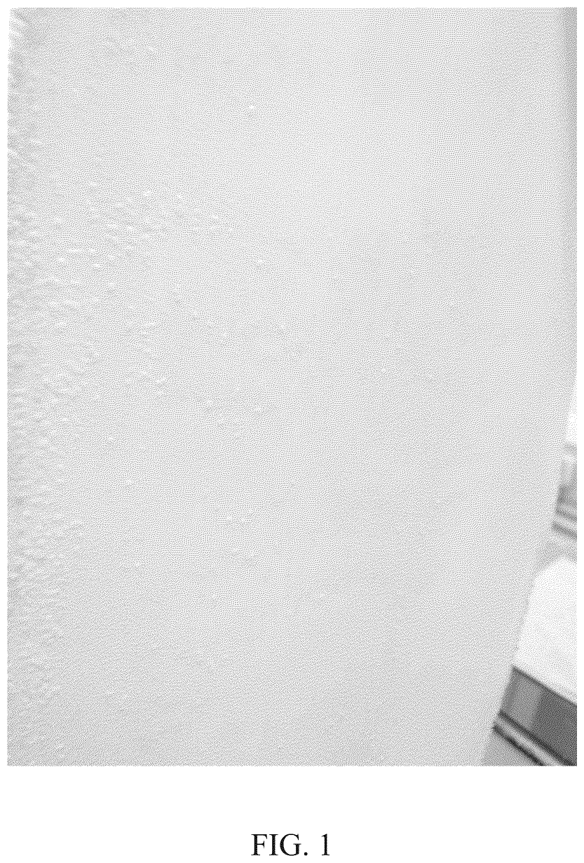

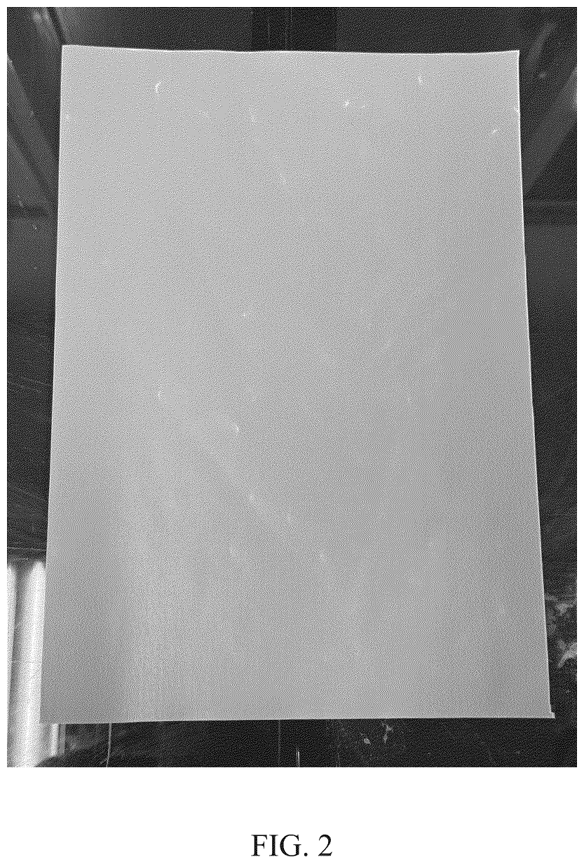

The prepregs 1 were provided which were prepared by impregnating 2116 E-glass fiber fabric with each sample to be tested (each of Embodiments or Comparative embodiments). Whether the appearance of prepreg 1 was smooth and powder fallen off was visually observed. If the prepreg 1 has a smooth appearance and no powder falls off, it is recorded as “OK”. The schematic diagram showing the smooth appearance of the prepreg 1 is shown in FIG. 2. If the prepreg has an uneven appearance or powder loss, it is recorded as “NG”. The schematic diagram showing the uneven appearance of the prepreg is shown in FIG. 1.

### Appearance of the Copper-Free Laminate

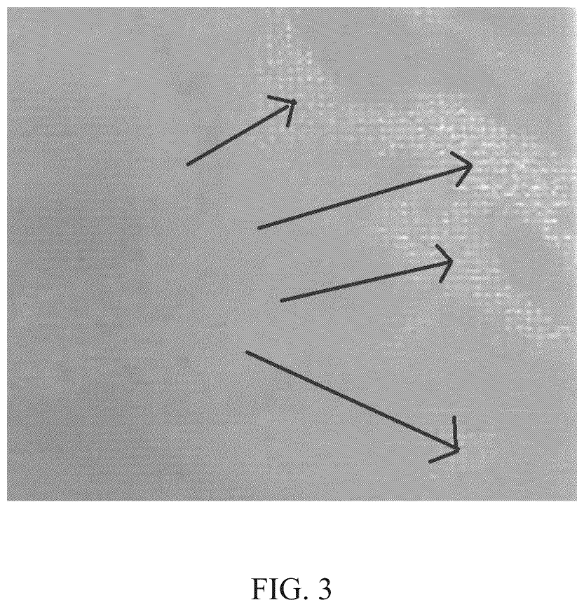

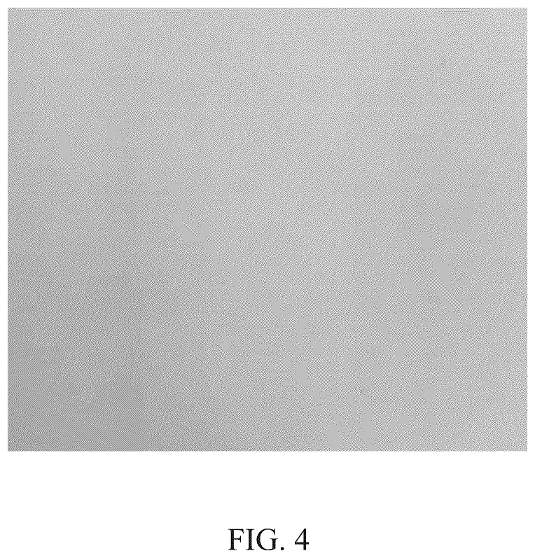

The surface condition of the insulating layer of the above-mentioned copper-free laminates (formed by laminating eight prepregs 1) was determined by visual observation. The appearance of the surface insulation layer of the copper-free laminate was visually observed to determine if there was any dryness or discoloration. The schematic diagram showing the distribution of the dryness is shown in FIG. 3. Dry board means that the surface of the insulation layer of the copper-free laminate has exposed texture (or it is called lack of glue on the surface of the insulation layer). The schematic diagram showing the surface insulation layer of the copper-free laminate without dry board is shown in FIG. 4. The presence of dry areas on the surface insulation layer of the copper-free laminate may cause uneven characteristics (poor reliability) of subsequent circuit boards and significantly reduce the yield. For example, it may cause shortcomings such as poor dielectric properties, low heat resistance, uneven thermal expansion, or poor interlayer contact. Circuit boards with the aforementioned shortcomings will be scrapped directly. The appearance of the copper-free laminates of Embodiments (E1 to E6) does not have any dryness or discoloration.

### Water Absorption Rate of the Pressure Cooking Test (PCT)

Copper-free laminates (which was prepared by lamination eight prepregs 1) with 2-inch long and 2-inch wide were provided as the samples to be tested. Each sample to be tested was baked in an oven at 105±10° C. for 1 hour, taken out, cooled at room temperature (about 25° C.) for 10 minutes, and then weighed the copper-free laminate to determine the weight W1. Then, referring to the method described in IPC-TM-650 2.6.16.1, a pressure cooking test (PCT) was performed, and the sample to be tested absorbed moisture for 3 hours (the test temperature was 121° C., and the relative humidity was 100%). The remaining water on the surface of the sample was removed. After water removing, the weight of the copper-free laminate after absorbing water was measured, which is W2. According to the equation: water absorption rate W (%)=[(W2−W1)/W1]×100%, the water absorption rate of the pressure cooking test (PCT) can be calculated. The unit of water absorption rate is %.

In the field of the present invention, the lower the water absorption rate, the better. When the difference in water absorption rates of different samples to be tested is greater than or equal to 0.010%, it means that there are significant differences in the water absorption rates between different laminates, which means there are significant technical difficulties. For example, the water absorption rate of an article made from the resin composition according to one embodiment of the present invention is less than or equal to 0.150%, for example, between 0.110% and 0.150%, and for example, between 0.110% and 0.130%.

According to the above embodiments, articles prepared by the resin composition of the present invention (for example, prepregs, resin films, laminates or printed circuit boards) have excellent characteristics in at least one of the copper foil peeling strength of the copper-containing laminate, the heat resistance of the multilayer laminate, and the appearance of the prepreg and the laminate. Therefore, the articles prepared by the resin composition of the present invention can be used as high-performance laminates that meet comprehensive needs.

The above embodiments are not intended to limit the claims of the present invention.

1. A resin composition, comprising:
100 parts by weight of vinyl-containing polyphenylene ether resin;
20 parts by weight to 60 parts by weight of a compound represented by the following formula (1); and
20 parts by weight to 60 parts by weight of an ethylene-styrene-divinylbenzene terpolymer, 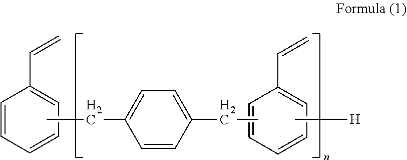
wherein n is an integer ranging from 1 to 20.

2. The resin composition of claim 1, wherein the vinyl-containing polyphenylene ether resin comprises: vinylbenzyl group-containing polyphenylene ether resin, (meth)acrylate-containing polyphenylene ether resin, vinylbenzyl group-containing bisphenol A polyphenylene ether resin, maleimide-containing polyphenylene ether resin or a combination thereof.

3. The resin composition of claim 1, wherein a number average molecular weight (Mn) of the ethylene-styrene-divinylbenzene terpolymer ranges from 5,000 to 15,000.

4. The resin composition of claim 1, wherein the ethylene-styrene-divinylbenzene terpolymer is polymerized from a mixture; wherein the mixture comprises 40 mol % to 80 mol % of an ethylene monomer, 20 mol % to 60 mol % of a styrene monomer and 0.01 mol % to 10 mol % of a divinylbenzene monomer, and a total amount of the ethylene monomer, the styrene monomer and the divinylbenzene monomer is 100 mol %.

5. The resin composition of claim 1, further comprising: maleimide resin, polyolefin other than the ethylene-styrene-divinylbenzene terpolymer, acrylate, triallyl isocyanurate, triallyl cyanurate, styrene maleic anhydride copolymer resin, phenol resin, benzodiazepine resin, cyanate resin, polysiloxane resin, polyester resin, epoxy resin, polyamide resin, polyimide resin or a combination thereof.

6. The resin composition of claim 1, further comprising: polyolefin other than the ethylene-styrene-divinylbenzene terpolymer, and a content of the polyolefin other than the ethylene-styrene-divinylbenzene terpolymer ranges from 5 parts by weight to 50 parts by weight.

7. The resin composition of claim 6, wherein the polyolefin other than the ethylene-styrene-divinylbenzene terpolymer comprises vinyl-containing polyolefin, hydrogenated polyolefin or a combination thereof.

8. The resin composition of claim 7, wherein the vinyl-containing polyolefin comprises: polybutadiene, polyisoprene, styrene-butadiene copolymer, styrene-isoprene copolymer, styrene-butadiene-divinylbenzene terpolymer, butadiene-styrene copolymer adducted with maleic anhydride, vinyl-polybutadiene-urea ester oligomer, polybutadiene adducted with maleic anhydride or a combination thereof.

9. The resin composition of claim 7, wherein a content of the vinyl-containing polyolefin ranges from 5 parts by weight to 20 parts by weight.

10. The resin composition of claim 7, wherein the hydrogenated polyolefin comprises hydrogenated styrene-butadiene-styrene block copolymer, hydrogenated styrene-butadiene-styrene block copolymer substituted with maleic anhydride, or a combination thereof.

11. The resin composition of claim 7, wherein a content of the hydrogenated polyolefin ranges from 6 parts by weight to 30 parts by weight.

12. The resin composition of claim 1, further comprising: an inorganic filler, an inhibitor, a flame retardant, a colorant, a toughener, a core-shell rubber, a silane coupling agent, a solvent or a combination thereof.

13. An article manufactured using the resin composition of claim 1, wherein the article includes a prepreg, a resin film, a laminate or a printed circuit board.
